(19) United States
(12) Patent Application Publication
(10) Pub. No.: US 2017/0364537 A1
(43) Pub. Date: Dec. 21, 2017

(54) IMAGE-AIDED DATA COLLECTION AND RETRIEVAL

(71) Applicant: Alexander Kariman, Rockville, MD (US)

(72) Inventor: Alexander Kariman, Rockville, MD (US)

(73) Assignee: Secrom LLC, Reston, VA (US)

(21) Appl. No.: 15/677,037

(22) Filed: Aug. 15, 2017

(51) Int. Cl. G06F 17/30; H04L 29/06; G06Q 10/06; H04N 7/15

(52) U.S. Cl. CPC G06F 17/30256; G06Q 10/0637; H04L 63/1433; G06F 17/3028; G06Q 10/0635; G06F 17/30867; H04N 7/15

(57) ABSTRACT

The disclosed invention includes a method and a system for performing image-aided data collection and retrieval, where the data collection and retrieval is related to one or more persons, or subjects or objects associated with one or more persons. The data collection and retrieval is performed with the help of one or more images that contain one or more objects of interest and at least some annotation data related to at least one object of interest. The data collection and retrieval involves: image and annotation collection, image analysis and searching for similar images, data searching and processing, results aggregation and presentation, and optionally collection of feedback.

### FIELD OF THE INVENTION

This invention relates to an information collection and retrieval system, which enables collection and retrieval of data using annotated images. The data retrieved involves information about people and subjects and objects directly or indirectly associated with people.

### BACKGROUND OF THE INVENTION

The described invention proposes new systems and methods for improving productivity of employees, decision support, and security risk management, addressing several key issues that organizations and people confront today.

Effective internal information sharing in large companies is often a problem, leading to development of knowledge silos that demote cooperation, create duplicate efforts, reduce productivity, and increase costs. Business development, sales, and procurement personnel meet new people daily, but the knowledge about these meetings is rarely shared across the organization, beyond generic management tools.

Timely knowledge about encounters and people, the context, the outcomes, and possible complications—all, are essential for productivity and security management. Today, many face-to-face meetings take place in the cyberspace. Employees often have little time and ability to make inquires or conduct due diligence on people they meet. Employees need information that is meaningful and actionable, delivered in real-time to provide decision support and increase productivity.

Security risk management is another important field. International organizations with travelling employees, companies working in high risk environments or having significant exposure to fraud, walk-in businesses, and others—are all subject to physical security risks, and need a cost-effective solution to address the security challenges. Ability to obtain instant background information, actionable intelligence, relevant analytic judgments, proactively notify the authorities, or simply receive an alert if a threat is detected, is important for safety and security of businesses and employees.

A variety of visual query-based search systems are known. However, they are not intended to provide real-time decision support, productivity and security risk management. The proposed invention presents a number of innovations, both, in the technical field and the application. In some embodiments, the proposed invention provides not only a convenient mechanism for near-real-time retrieval of actionable information, but it also provides a mechanism for collecting, using, and refining new, highly targeted information, in addition to improving the current knowledge, ideally, with every retrieval transaction.

In one disclosure, for example, as described in the U.S. Pat. No. 9,195,898 B2 (Publication date Nov. 24, 2015), there are systems and methods for real-time image recognition and mobile visual searching, where a mobile device acquires an image, detects one or more objects, receives input from user, indicating at least one of the detected objects, generates metadata associated with the selected object, extracts a query-image based on the selected object, generates a visual search query that includes the query image and the metadata, wirelessly communicates the visual search query, and receives and presents information associated with at least one object.

The aforementioned disclosure does not provide a mechanism for collecting and re-using relevant information, such as a user-provided, or in some cases, a device-provided object annotation, but merely provides a generic, device-generated image metadata, which is based on the device-categorized or recognized objects in the image and some image-contextual (not object-contextual) data collected via the device sensors.

In another disclosure, for example, as described in the U.S. Pat. No. 9,135,277 B2 (Publication date Sep. 15, 2015), a client system submits a visual query having two or more specific distinct object types to a visual query search system. The search system processes the visual query by sending it to a plurality of parallel search systems, each implementing a distinct visual query search process. Then at least one search result is sent back to the client system for obtaining one or more user annotations of a specific result, indicating a respective search result's relevancy to the visual query, then obtaining a second visual query and obtaining a second search result based on at least one annotation in the one or more user annotations.

In another disclosure, for example, as described in the U.S. Pat. No. 7,810,020 B2 (Publication date Oct. 5, 2010), there is an information retrieval system comprising of an apparatus that extracts episodic information on each participant of an audio/video conference from a sound and an image that are captured during the conference. The system further comprises of an information storage portion that stores the extracted episodic information associated with personal information related to each participant. And the system also includes an information retrieval portion that retrieves personal information based on any of the extracted episodic information that includes: number of conversation times, number of remark times, total conference conversation period, etc.

In another disclosure, for example, as described in the U.S. Pat. No. 9,384,408 B2 (Publication date Jul. 5, 2016), there are systems and method for obtaining contextual information of an image published on a digital medium to generally identify and analyze the image using textual tags from text published proximate to the image, which function to describe, identify, index, or name the image or content within the image. The textual descriptors are then matched to the image descriptors to provide contextual information of the published image.

In another disclosure, for example, as described in the U.S. Pat. No. 8,559,682 B2 (Publication date Oct. 15, 2013), there are systems and methods for automatically identifying a name of a person in an image. The identifying includes detecting visual features from a received image and collecting visually similar images to the received image along with text that is proximate or surrounding the visually similar images. A name, or other information, is determined from the text and then output to a user.

### SUMMARY OF THE INVENTION

The following methods and systems present a simplified view of one or more aspects of the proposed invention. This summary is not an extensive overview of all contemplated embodiments and implementations. It is intended to neither identify key or critical elements of all features, nor delineate the scope of any or all facets. Its sole purpose is to present some concepts of one or more aspects in a simplified form.

According to the present teachings in one or more aspects, the methods and systems provided herein are for performing image-aided data collection and retrieval, where the data collection and retrieval is related to one or more persons, or subjects or objects associated with one or more persons. The data collection and retrieval is performed with the help of one or more images that contain one or more objects of interest and some annotation information related to one or more objects in the image.

A data retrieval query starts with a capable electronic device acquiring an image, using, for instance, a camera, and obtaining some annotation data associated directly or indirectly with one or more objects in said image. A device user can provide said annotations using a user interface, and/or the device can provide said annotations by automatically capturing any relevant information available to the device (e.g., location information, time, device name, user name, information pre-configured by user or device manufacturer, information selected as a result of image pre-processing, etc.). The device can then pre-process, if necessary, any image and annotation data, and/or transmit this information without the pre-processing over a network, such as the Internet, to one or more server-systems for processing.

The server-system receives said information (image-aided query) and processes it. Once the information is processed, the server-system transmits a report back to the device, where the report includes at least some information related to one or more persons and/or subjects or objects related to a person; for instance: a motor vehicle make/model that belongs to a person on the image; or to the contrary: an annotated image of a motor vehicle yields the owner's name, address, and picture. The user can then review the report and provide, if necessary, some feedback with additional details, if known to the user, which enhances the knowledge about the person, and/or related subject or object (such as a motor vehicle), as well as it increases the accuracy and completeness of future reports.

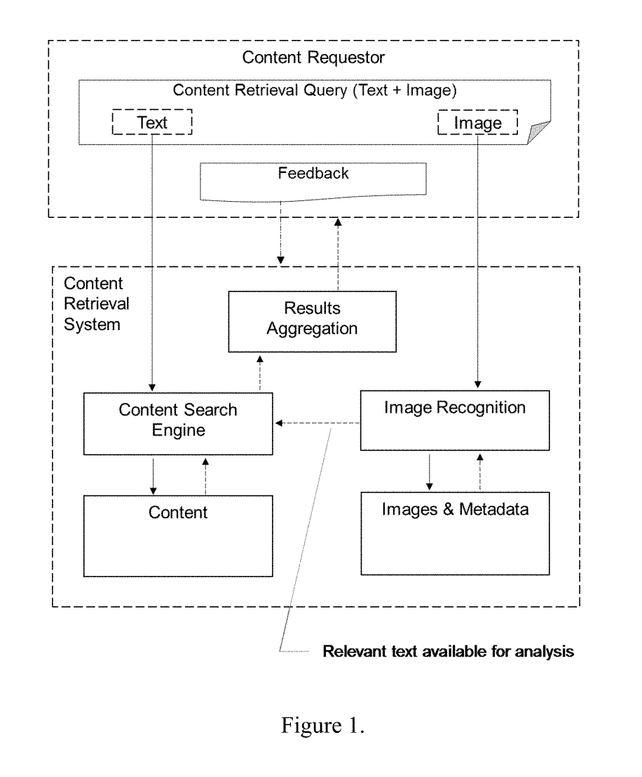

A conceptual outline of one of the many possible embodiments of the proposed invention is presented in the FIG. 1. A content requestor generates an image-aided query that consists of an image and some annotation text relevant to an object in the image. The content requestor sends this information to a content retrieval system that includes a logical content search engine and a logical image recognition system, each being coupled with a corresponding logical data storage, and a logical results aggregation system. The image recognition system processes the image and finds visually similar images and associated data. The image analysis system provides to the search engine any discovered relevant text for analysis, and makes available to the results aggregation system any images for inclusion, if necessary, in the report. The search engine searches for relevant content based on the annotation text and the relevant text discovered/generated by the image analysis system, and provides the results to the results aggregation system. The results aggregation system compiles a report as required, and sends it to the content requestor. The content requestor receives the report and provides optional feedback with additional known details (if any) back to the content retrieval system.

In one embodiment of the proposed invention, a premises video surveillance system that automatically and continuously records and transmits a video data stream, captures a video frame containing a visitor (person). The video surveillance system automatically annotates the video with a pre-set camera location information, pan angle, time-stamp, and an audio snippet (or a continuous stream). The surveillance system submits the image-aided query by continuously streaming the video and the annotation to the server-system for processing (and in another implementation, by periodically sending one or more video frames and annotations).

The server-system identifies, before the visitor gains access, that the visitor is a human with his head partially covered, who is a male, and of a certain age group, and from a certain geographic area, for instance, by a combination of the person's wardrobe items and their position, as worn by males of a certain age group in a certain geographic area.

Furthermore, the camera location information and the pan angle suggest to the server-system that the object captured is likely to be a person since the camera was pointed at the entrance door with a lock lever, corroborating the conclusion of the image analysis. In addition, the audio data is used to generate a voice model and analyze conversation content to attempt to determine the person's intent, generating a voice model and checking the model against a known-person database, and then storing the voice model, the conversation content, and the metadata for future references.

In addition, the server-system concludes that the person is distressed, using face emotions and behavioral recognition technologies. Further, the server-system identifies a tattoo on the person's wrist, using image enhancement techniques, that is distinctive of a certain threat-actor group. It also identifies that the individual's hands are visible and free of items resembling a weapon.

Next, the server-system obtains a risk profile of the threat-actor group, calculating the person's security risk factor based on the aforesaid “situational” information, available historic/statistical information relevant to the case, criminal record, if the person was identified, and the real-time information supplied by a local news media, and/or the law enforcement, and/or social media, to determine the criminal activity and current alerts in the area, etc. The server-system then calculates a final risk factor and determines appropriate action, where in one implementation, such action includes proactively locking the entrance door, sending alerts (e.g., SMS, automated phone call, etc.) to the nearest security personnel, and sending a detailed report to the designated person (e.g., an officer on duty).

In another embodiment of the proposed invention, an employee, participating in a video conference call using a mobile app, captures a facial image of another participant using either another app or a feature of the video conference app, then provides some annotation for the captured image, such as the person's first name, telephone number, email address, etc., and sends the image-aided query to the server-system for processing.

The server-system identifies said person using facial recognition technology, searches multiple databases, and finds relevant information about the person (e.g., last name, date of birth, previous encounters by other employees, criminal and other governmental records, social network accounts, associated people and business entities, etc.). The server-system then sends this information back to the mobile app, in one embodiment, initiating the transmission using a push message. If user then decides to upload the report, the app uploads the report and displays it to the user. The user meanwhile remains on the conference call with the conversation participant. The user can review the report and provide additional information, if known, by sending some feedback to the server-system.

The feedback interface, in this implementation, also includes an optional questionnaire, if the server-system determines some critical information gaps concerning said individual, that the user may be able to fulfil. The questionnaire, in one implementation, is automatically compiled as part of the image-aided query processing, if the server-system identifies critical information gaps and believes that the user may have the knowledge and ability to fulfill them. The server-system also assembles a wiki-type profile for each encountered individual, as part of the one or more wiki-type profile repositories, consisting of information compiled as a result of processing image-aided queries, other relevant information provided by users, and information amassed from other resources (not part of the query processing).

In another embodiment of the proposed invention, a private investigator takes a partial shoe print image using an app on his/her mobile device, provides some annotation of the object depicted in the image, possible clues as to the shoe print origin, and enhances the image using the app's built-in feature, reconstructing the entire shoe print to obtain the shoe size. The app then sends the image-aided query to the server-system, but before the transmission, it determines that the network bandwidth is low and pre-processes the image to reduce the image size.

The server-system receives and processes the pre-processed image and annotations to find possible matches and associations with people, objects, and any prior query requests. The server-system analyzes the data with the help of a specialized third-party system, determines the shoe brand and model, finds similar cases, and returns the results along with suggestions to the private investigator while the investigator is still on the site and able to make more image-aided requests.

In another embodiment of the proposed invention, a medical nurse takes patient's image using a specialized hand-held device. The image includes some part of the patient's body but not the face, and a partially visible tag, containing only the patient's first name and a month of birth. The device automatically collects additional annotations: a nearby RFID data for in-door location, a timestamp, and a name of the logged-in user (nurse), etc. In addition, the nurse dictates some speech-to-text annotations related to the patient's medical condition. The device then sends this image-aided query to the server-system for processing and the server-system returns the patient's medical record with a list of previous encounters, automatically adds to the record a transcript of the annotations provided by the nurse, including the nurse's name, time, and place of the encounter. The nurse verifies the information, corrects any discrepancies, and approves the information, sending the feedback to the server-system.

In another embodiment, having a need to quickly alert the authorities in an emergency, such as a car accident, a person takes a photograph of the accident site using a smart-phone and provides minimal annotations, such as selecting a “car accident” option (e.g., a hot-key presented to him or her as a result of image pre-processing, etc.). The image also includes a partially visible license plate of one of the vehicles and a person on the ground. The smart-phone automatically attaches location data (e.g., a GPS fix) and a timestamp. The smart-phone then sends the image-aided query to the server-system for processing and the server-system recognizes (objects and their attributes) as the car accident site, involving at least one possibly injured person, identifies visible characters on the license plate and the vehicle model, searches a database to identify the vehicle's owner, automatically notifies local emergency services, providing them the location data and time, as well as the relevant details received and produced as part of the image-aided query processing. In addition, the server-system sends to the first individual some instructions concerning immediate actions in this type of emergency before the response team arrives to the site.

In another embodiment of the proposed invention, a victim of a minor hit-and-run car accident takes a picture of the departing vehicle with his or her camera phone, where the departing vehicle is at some distance. Then he/she provides relevant details, inputting annotations into the app interface. The app then adds information such as location and timestamp. The phone then sends the image-aided query to the server-system for processing, and the server-system returns the instances of encounters of similar vehicles in the given geographical area (using images from street cameras), as well as identifies, using image enhancement techniques, some distinctive traits of the hit-and-run vehicle (e.g. a bumper sticker, a fender damage, etc.). In another implementation, the server-system creates a task-alert where the server-system would continuously monitor for encounters with said hit-and-run vehicle and would alert the victim if a resemblance vehicle is identified, either as part of another image-aided query or as part of collecting or searching other resources (new images from street cameras, motor vehicle administration records, or any other records, etc.).

### BRIEF DESCRIPTION OF THE DRAWINGS

The accompanying drawings, which are incorporated in and constitute a part of this specification, illustrate aspects of the present teachings and together with the description, serve to explain principles of the present teachings.

The FIG. 1, provides a conceptual outline of one of many possible embodiments of the proposed invention, where a content requestor generates and sends an image-aided query to a content retrieval system that includes a search engine and an image recognition system, each being coupled with a corresponding logical data storage, and a logical results aggregation system. The image recognition system processes the image and provides to the search engine any discovered relevant text for analysis, and makes available to the results aggregation system any images for inclusion, if necessary, in the report. The search engine searches for relevant content based on the annotation text and the relevant text discovered/generated by the image analysis system, and provides the results to the results aggregation system. The results aggregation system compiles a report and sends it to the content requestor. The content requestor receives the report and optionally provides feedback with additional known details back to the content retrieval system.

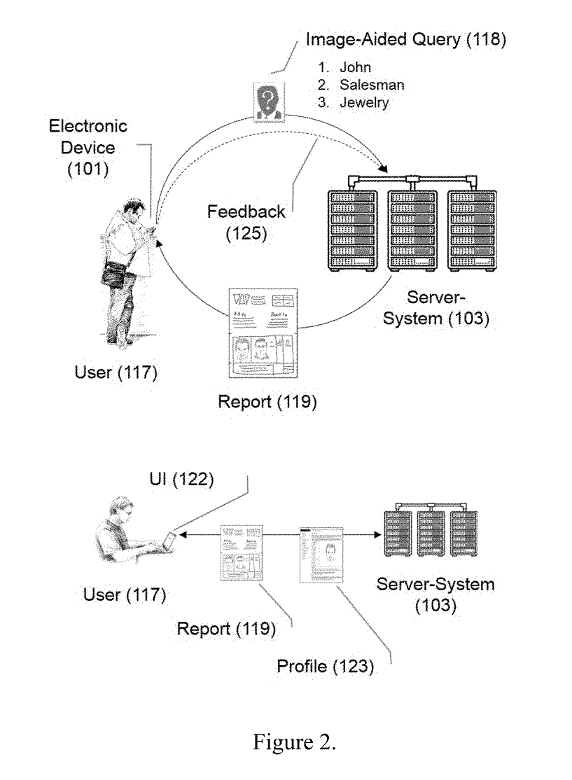

The FIG. 2, provides a schematic view of the interaction between a user and a server-system, where the user initiates an image-aided data retrieval query, sending to the server-system a request, consisting of an image and some annotations, and receiving from the server-system a report, and then sending feedback to the server-system. The FIG. 2, also provides a schematic view of the interaction between a user and a server-system, where the user accesses the server-system via a user interface to view reports and wiki-type profiles.

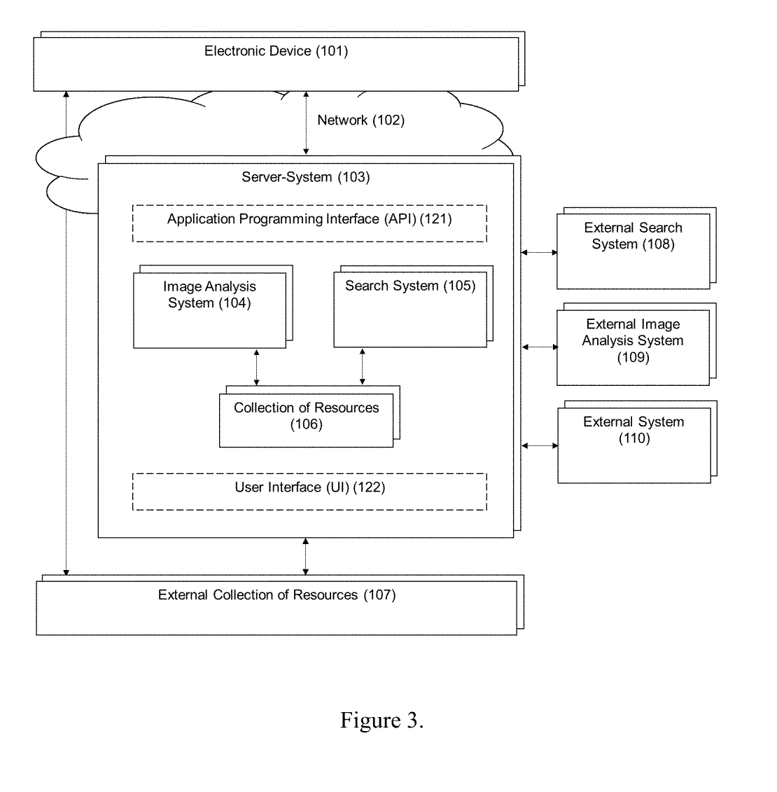

The FIG. 3, provides a basic view of the server-system and its main subsystems that include: one or more image analysis systems, one or more search systems, one or more collections of resources, as well as external systems and multiple interfaces.

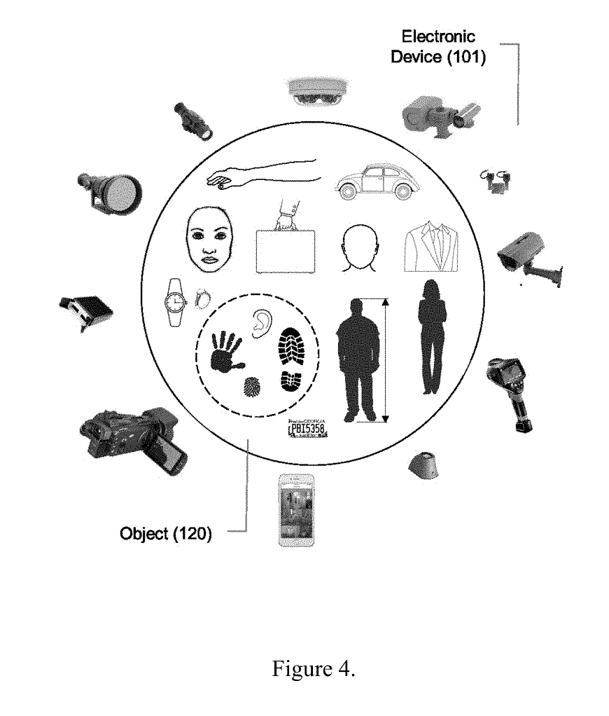

The FIG. 4, provides an example of some, among many possible, objects and electronic devices.

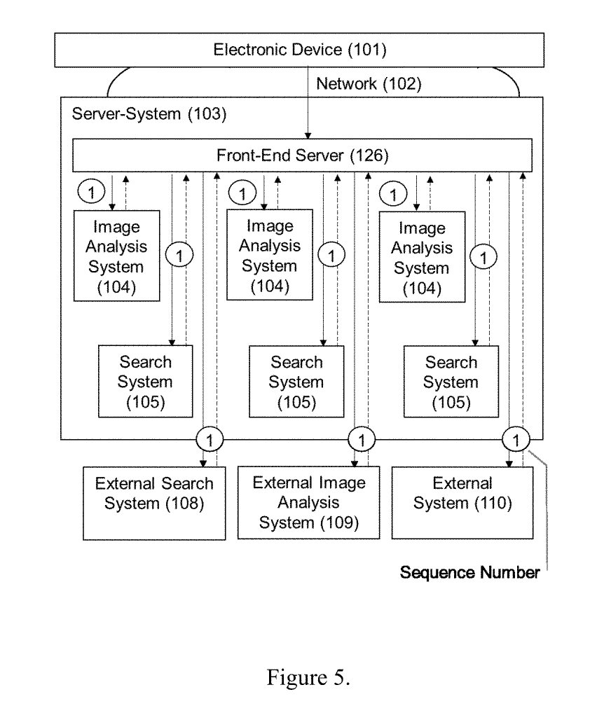

The FIG. 5, depicts an embodiment, where an image-aided query is processed concurrently, sending the image-aided query to one or more image analysis systems, and one or more search systems, and one or more external systems in parallel.

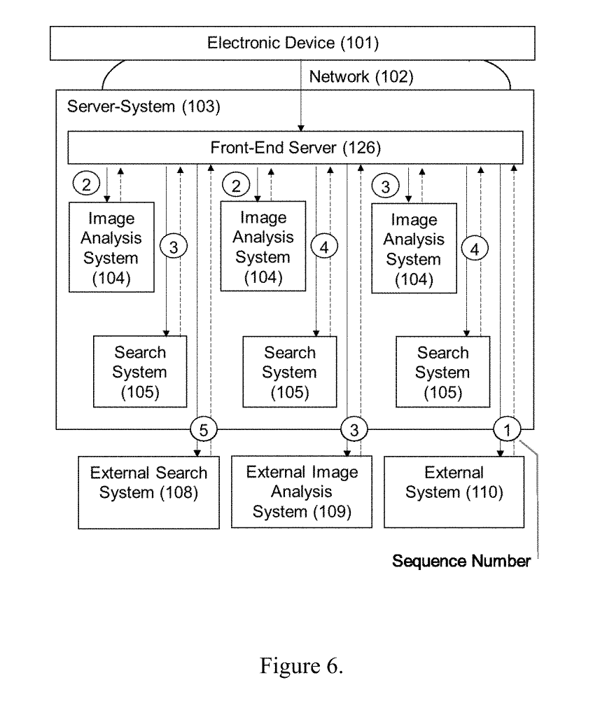

The FIG. 6, depicts an embodiment that is similar to the FIG. 5, but where the certain steps of the image-aided query processing are executed consequently and others concurrently.

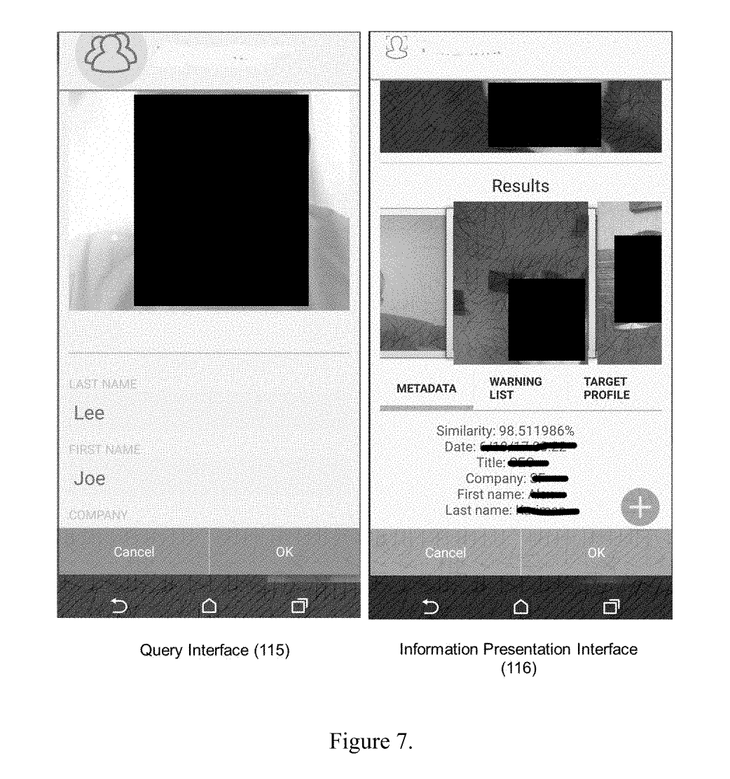

The FIG. 7, depicts some of the mobile application-implemented query and report interfaces.

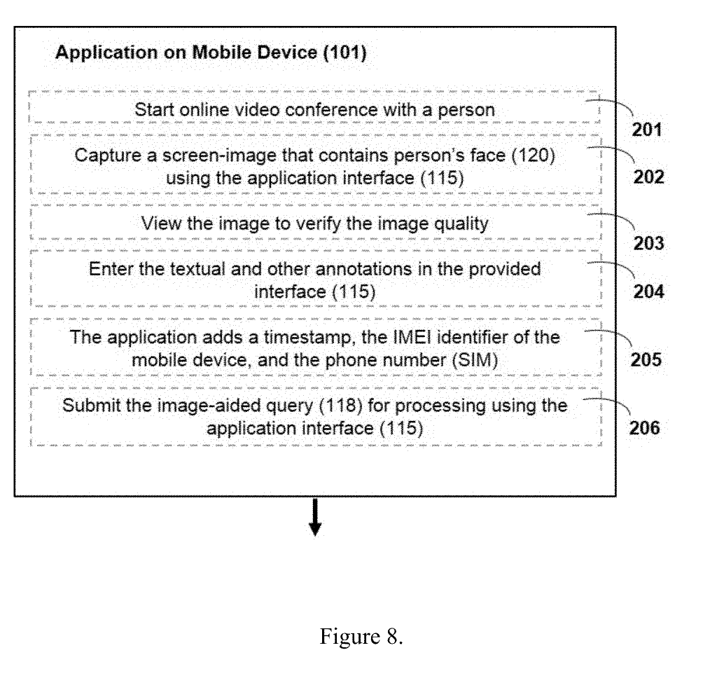

The FIG. 8, provides a general overview of one embodiment, where the image-aided data collection and retrieval system and method are integrated into a teleconferencing system, and the illustration depicts some events of initiating an image-aided query in a mobile teleconferencing application.

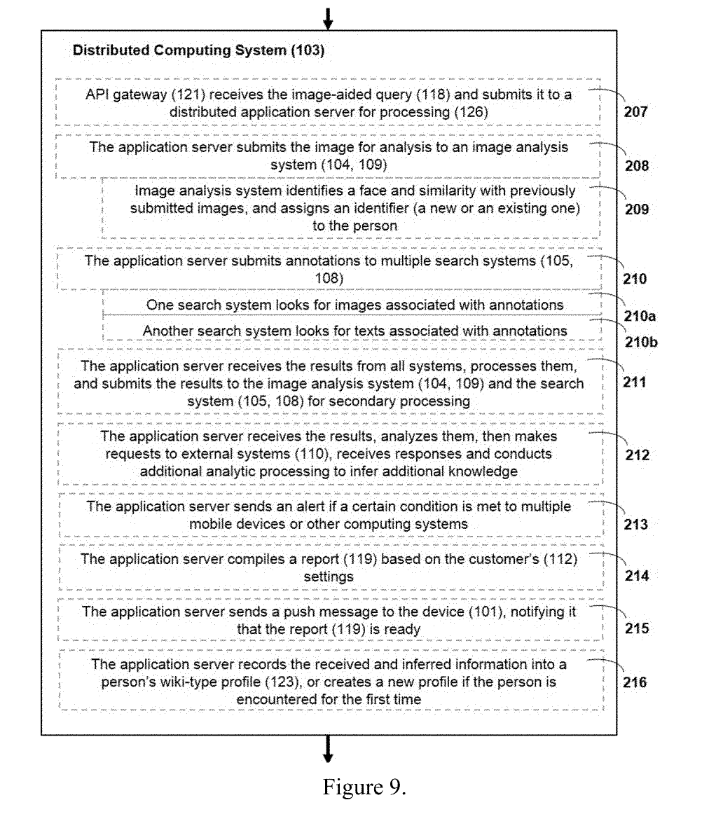

The FIG. 9, provides a general overview of one embodiment, where the image-aided data collection and retrieval system and method are integrated into a teleconferencing system, and the illustration depicts some events of processing an image-aided query on the server-system.

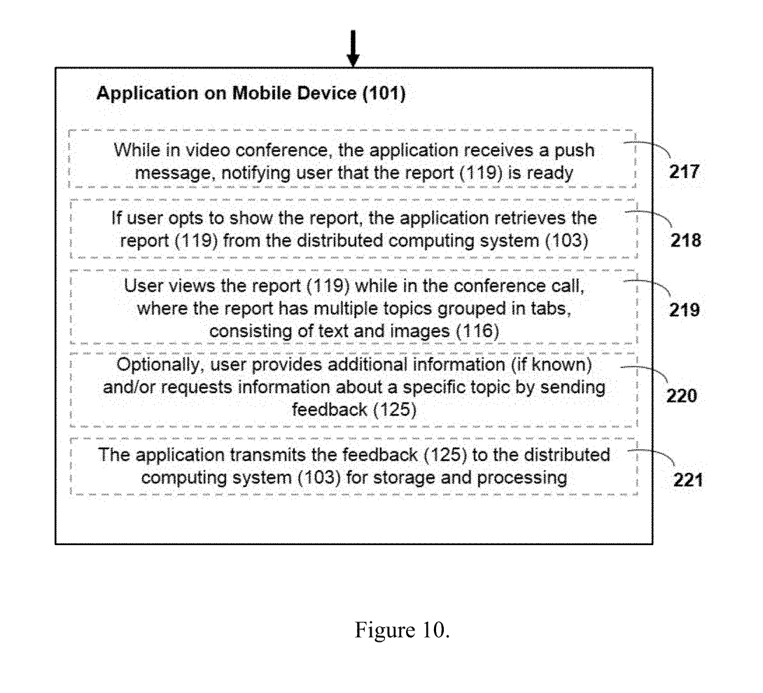

The FIG. 10, provides a general overview of one embodiment, where the image-aided data collection and retrieval system and method are integrated into a teleconferencing system, and the illustration depicts some events of a mobile teleconferencing application receiving an image-aided query report and performing some subsequent steps.

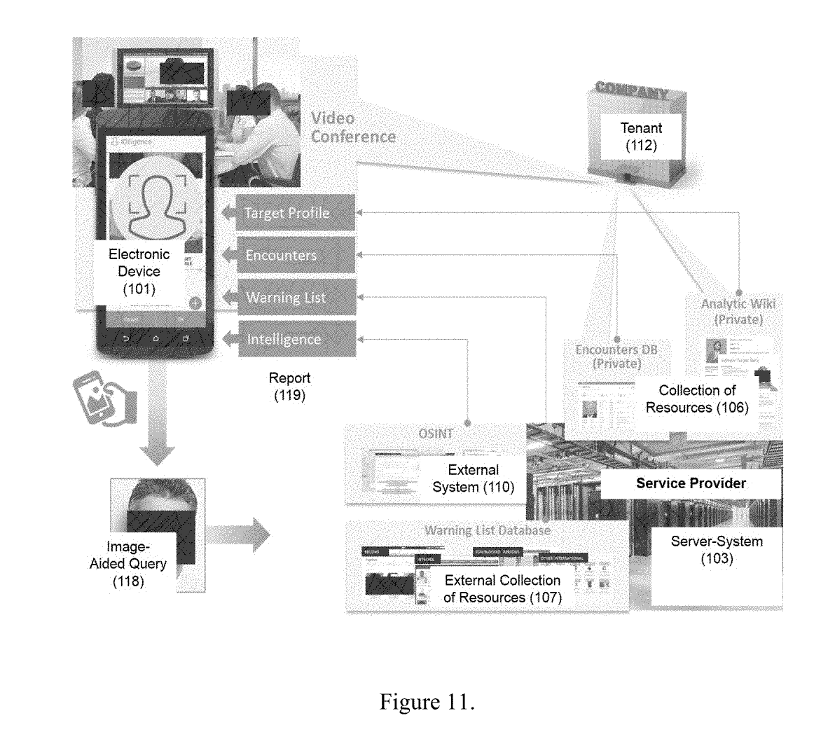

The FIG. 11, provides a general overview of one embodiment, where the image-aided data collection and retrieval system and method are integrated into a teleconferencing system (solution), and the illustration depicts a customer receiving said solution as a service, having some private resources, namely: the Encounters DB (database), the Analytic Wiki (wiki-type profile repository), and the Video Conference system; and having some shared resources (all others) that are provided by the service provider as part of the solution.

### DESCRIPTION OF EMBODIMENTS

Reference will now be made to embodiments, examples of which are illustrated in the accompanying drawings. In the following description, some details are set forth in order to provide understanding of the proposed invention. However, it will be apparent to one of ordinary skill in the art that the present invention may be practiced without these details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. Moreover, the term “or” is intended to mean an inclusive “or” rather than an exclusive “or.” That is, unless specified otherwise, or clear from the context, the phrase “X employs A or B” is intended to mean any of the natural inclusive permutations. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if is detected” may be construed to mean “upon determining” or “in response to determining” or “upon detecting (the stated condition or event)” or “in response to detecting (the stated condition or event),” depending on the context.

As used herein, the terms “produced data”, “data produced” “located data” or similar, depending on the context, also includes data about absence of data or a result. For instance, a database query that produced no results relevant to the query had produced data about absence of the results (data in the database). In another instance, an image analysis system that did not produce results of image analysis (data), had produced results (data) about the absence of results (data) for whatever reason, such as inability to process the image, an error, no data produced as a result of image processing, etc.

As used herein, the terms “data related”, “related data” or “related information”, “information related”, or “related”, or “in connection”, or “associated”, or “relevant”, and similar, depending on the context, means any association, whether direct or indirect, by any applicable criteria as the case may be.

The word “exemplary” is used herein to mean “serving as an example, instance, or illustration”. And no aspect of this disclosure shall be construed as preferred or advantageous over other aspects or designs unless expressly stated.

Each of the operations described herein may correspond to instructions stored in a computer memory or computer readable storage medium. Each of the methods described herein may be governed by instructions that are stored in a non-transitory computer readable storage medium and that are executed by one or more processors of one or more servers or clients.

The term “push” or “push message” or “push technology” may also mean a server initiating data transfer rather than a client, or a push messaging service. The term “pull” or “pull technology” may also include network communications where the initial request for data originates from a client, and then it is responded to by a server. The term “operating system” may be understood as an independent program of instructions and shall furthermore include software that operates in the operating system or coupled with an independent program of instructions.

A “circuit” or “circuitry” may be understood as any kind of logic-implementing entity, which may be hardware (including silicon), software, firmware, net-ware, or any combination thereof. Thus, a “circuit” or “circuitry” may be a hard-wired logic circuit or a programmable logic circuit such as a programmable processor, e.g. a microprocessor, a computer, a network of computers, a distributed computing system (or infrastructure), and the like. A “circuit” or “circuitry” may also be software being implemented or executed by a processor, e.g., any kind of computer program. It may also be understood to be a computing service (e.g., Infrastructure or Software-as-a-Service, etc.) Any other kind of implementation of the respective functions described herein may also be understood as a “circuit” or “circuitry”.

A “processor” may also be understood as any number of processor cores or threads, controller, or microcontroller, or plurality and combination thereof. The terms “coupling” or “connection” or “linking” are intended to include a direct coupling or a direct connection, as well as an indirect “coupling” or an indirect “connection” respectively, as well as logical or physical coupling and communicative or operational coupling, which means coupling two or more discrete systems or modules, or coupling two or more components of the same module respectively. A “coupled or connected device” or similar, may be understood as a physical, a logical, or a virtual device.

A “network” may be understood as any physical and logical network, including the Internet, local network, wireless or wired network, or a system bus, or any other network, or any physical communication media, or any combination of any networks of any type. A “message” or a “notification” may be used interchangeably and may be understood to mean “data”.

A “memory” may be understood to be any recording media used to retain data that includes, without limitation: high-speed random-access memory, such as DRAM, SRAM, DDR RAM or other random-access memory, non-volatile memory, such as one or more magnetic disk storage devices, optical disk storage devices, flash memory devices, or other non-volatile storage devices. It may also be understood to include one or more storage devices remotely located from the processor(s); and the non-volatile memory device(s) within memory, comprising of a non-transitory computer readable storage medium, or any other electronic data storage medium.

An “image”, or “picture”, or “video” may be understood to include all types of images, without limitations, including: any data structure comprising of any array of pixel information, photographs, scanned documents, motion pictures, videos, streaming videos, any video frame, drawings, or products of any electro or radio magnetic, acoustic, passive or active imaging, or any other type of imaging that can be processed by an image analysis system. An image may or may not contain one or more clusters of salient features (e.g., features, objects of interest, etc.) that correspond to one or more objects.

An “electronic device”, or “device”, or “client device” may be understood to be any circuitry, including one or more applications, such as a browser plug-in application, a search engine extension, an “omnivorous” user interface box, which allows users to upload images and provide annotations, any server or client endpoint, or any electronic circuit, such as, without limitations: a video surveillance system, a teleconferencing system, a distributed computing system, a desktop, a tablet or notebook computer, a mainframe computer, a server computer, a mobile device, a mobile phone, a personal digital assistant, a network terminal, a set-top box; or a specialized device, such as, without limitations: electronic binoculars, a biometric scanner, an electronic aiming scope, a target acquisition system, an electronic video camera, a radar, a laser, a thermal camera, a night-vision camera; or any other device capable of producing data that can be processed by an image analysis system.

A “server-system” may be understood to be any network-enabled electronic circuit, such as, without limitations: a distributed computing system, a server computer, a desktop, a tablet or a notebook computer, a mainframe computer, a mobile device, a cloud computing service, a server-less computing service that can execute programs, or any combination thereof; and to any extent of automation, including a significant part of the tasks described herein, requiring and performed using manual human labor.

An “image analysis system” may be understood to be any circuitry that can conduct content-based image analysis, and/or concept-based image analysis, and/or context-based image analysis, and/or other types of image analysis; and may consist, without limitation, of: a facial recognition system, an Optical Character Recognition (OCR) image recognition system, an image-to-terms image recognition system that recognizes objects or object categories, a 2-D entity image recognition system, a 3-D entity image recognition system, a 3-D pose estimation, a motion estimation, an image restoration and other enhancements/forensics, a named entity image recognition system; a landmark image recognition system, a corpus of specific images recognition system, such as radio-magnetic and acoustic images, ultra-high resolution images, biometric images or scans recognition (fingerprint, iris, etc.), place recognition aided by geo-location information, a color recognition image analysis system, a streaming video analysis system, emotions recognition and analysis system, behavior and pattern recognition and analysis system, and similar image analysis systems and techniques.

The image analysis system may utilize, without limitation, the following algorithms: scale-invariant feature transformation (e.g., SIFT, SIFT++, LTI-lib SIFT, and the like), speeded up robust features (e.g., SURF, SURF-d, and the like), augmented reality (e.g., BazAR, etc.), and algorithms for detecting the categories of, or categorizing, one or more objects in an image based on salient feature clusters corresponding to the objects in the image, such as a biological visual cortex network (e.g., Hierarchal Maximization Architecture, HMAX, etc.) and other object categorization algorithms and other algorithms known to those skilled in the art.

The image analysis system can enable visual searching in static or streaming data and deliver information associated with objects in images and/or patterns within images. Information associated with the objects can comprise visual, auditory, or sensory content, or a descriptor of a location to make such content accessible. For example, without limitations, the information content can be in the form of: an image, text, a Universal Resource Locator (URL), a Wireless Application Protocol (WAP) page, a Hyper Text Markup Language (HTML) page, an Extensible Markup Language (XML) document, a Portable Document Format (PDF) document, a database query, an executable program, a filename, an Internet Protocol (IP) address, a telephone number, a pointer, identifying indicia, or any other data in any format.

A “search system” may be understood to be any circuitry, including a distributed computing system, that can enable searching of at least some data in one or more collections of resources, and that can deliver at least some information associated with the query. Such information can comprise of visual, auditory, or sensory content, or a descriptor of a location to make such content accessible. For example, without limitations, the information content can be in the form of: an image, text, a Universal Resource Locator (URL), a Wireless Application Protocol (WAP) page, a Hyper Text Markup Language (HTML) page, an Extensible Markup Language (XML) document, a Portable Document Format (PDF) document, a database query, an executable program, a filename, an Internet Protocol (IP) address, a telephone number, a pointer, identifying indicia, or any other data in any format. In addition, the searching can be of static data or streaming data, and transactional or continuous, or any other kind.

An “image analysis” may be understood as application of one or more analysis techniques by the image analysis system, and/or searching the images and/or image-related data.

A “content-based image analysis”, also known as query by image content (QBIC) and content-based visual information retrieval (CBVIR) can be understood to mean that the analysis system examines the contents of an image rather than the image metadata. For example, without limitations, the contents may include: colors, shapes, textures, or any other information that can be derived from the image itself.

A “concept-based image analysis”, also known as “description-based” or “text-based” image analysis, means the system analyzes text-based metadata of images that may employ keywords, subject headings, captions, annotations, natural language text, and the like.

A “context-based image analysis” can be understood to mean that the analysis system examines the structure of an image where the knowledge takes mostly the form of statistical regularities within the local spatial context of an image region of interest, such as a document where the image is located. Here the context is defined as the description of the image content that comes from sources other than its visual properties. Typically, such content is expressed in term of textual information that comes from annotations, or surrounding text that is available with the image (e.g., captions, nearby text from web-pages containing the image, subtitles, etc.). The similarity between images is then assessed by also considering similarity between associated texts, using standard text retrieval techniques.

An “external source” or “external system” or “external” may be understood to be any circuitry, or any service, or any information resource, or any logical or physical system or module, or any data that exists logically or physically outside of the embodiment described, depending on the context, or that is sourced from an unrelated entity or third-party, or outsourced to a third-party. For instance, an external system can be, without limitations: a telecom company that provides SMS services used in one of the embodiments to send or receive SMS messages, or a push service provider, or, for instance, a motor vehicles records data provider, such as the Motor Vehicle Administration, etc.

A “collection of resources” may be understood to be a system, a platform, a circuitry, or a capability to retain and/or make available at least some data, whether the data is static or streaming, or some structured or unstructured data stored in one or more datastore, or any logical or physical recording media used to retain or stream at least some data, such as, without limitations: a memory, a hard drive, a database, a file system, a data stream, an archive, a library, a registry, a web-page, a knowledge-base, a metadata storage, a system log storage, etc., and any combination thereof.

An “analytic action” may be understood to be any data processing activity, or a process of, without limitations: discovery, transformation, interpretation, optimization, and communication of data; or activities that, without limitations: define, create, collect, verify, sort, or transform data into a more meaningful information, such as: reports, analyses, recommendations, optimizations, predictions, automations, and the like.

An “OCR character analysis” may be understood to be an Optical Character Recognition (OCR) system that is used to recognize fonts or text patterns, such as a vehicle license plate or a serial number.

A “person”, or “human”, or “individual” may be understood as a subject having a visually human appearance or attributes. The meaning also includes any elements, parts, and properties of the human body, as well as any common items, such as items of clothing, or as considered human-related by the image analysis system, or the search system, or the analytic action, or circuitry.

An “object” may be understood to contain one or more clusters of salient features that correspond to one or more objects. Object categories may include, unless expressly stated otherwise: natural objects, such as faces, animals, vegetation, land features; or man-made objects, such as logos, designs, buildings, landmarks, apparels, signs, vehicles, and the like. Although the terms “categories of objects” and “object categories” are used to describe sets of objects that share certain characteristics, other analogous terms known to one skilled in the art can be used interchangeably, such as classes of objects, kinds of objects, types of objects, and the like.

A “profile” may be understood to be a collection of information about a certain object, subject, location, or topic.

An “annotation”, or “annotation information”, or “annotation data” can be understood to be or include, without limitations: identifying indicia or any pointer related to an object; user-generated text or other data related to an object; electronic device-generated data related to an object (e.g., any descriptive text, any parameters, binary data, metadata, etc.); image metadata related to an object; device-accessible user data (e.g., pictures, documents, access credentials, settings, personal information, etc.); external data related to an object (e.g., data from sensors and other systems linked with the device); an audio, a video, or an image related to an object that is provided as annotation; a data stream related to an object that is provided as annotation; a speech-to-text recording related to an object; and the like.

The present teaching relates to systems and methods for information collection and retrieval with the help of annotated image analysis and searching. More particularly, in one or more embodiments of the proposed invention, and as exemplified in the FIG. 2, the systems and methods are provided in which one or more electronic devices (101) initiate an image-aided data retrieval query (118) upon a certain trigger (e.g., a user command or an event, etc.). The device then obtains one or more images and some annotation data, forms an image-aided data retrieval query (118), and sends the query (118) to one or more server-systems (103) for processing. The device (101) may obtain an image from a video camera or from a memory storage, or elsewhere; and the annotation data may be provided by user (117) via a query interface (115), or it could be produced automatically by the device without the user's (117) involvement.

Further, the image may or may not contain useful data, but ideally, it shall contain at least one object (120) and annotation relevant to the object (120). The server-system (103) then processes said query (118), and the electronic device (101) receives from the server-system (103) a response that includes a report (119) with at least some information in connection with one or more persons, and/or in connection with one or more subjects or objects that directly or indirectly relate to one or more persons.

In one embodiment, said report (119) consists of an interactive document and/or a list of results, and in another embodiment, the report (119) is presented in one or more application interface windows (116). In some embodiments, the list of results is organized into categories (116). Each category contains one or more types of results; and in some embodiments, a category title or another item can be an interactive tab or another active element.

In embodiments where more than one category is returned in the report (119), such as multiple images (116) or recognized objects (120), the category displayed first has a higher category weight. In embodiments where the image-aided query (118) includes more than one different face (multiple people), the server-system (103) may return a separate result for each identified person, subject or object. In some embodiments, the type of object (120) and/or annotation may dictate how the results are presented. And in another embodiment, the items included in the report (119) and/or presentation are configured by the user (117). In another embodiment, said report (119) may include, for example, without limitations: a binary response (e.g., yes/no, true/false, good/bad, etc.), and/or a scaled response (e.g., from a scale of 1 to 10), and/or information from previous queries (118), and/or include user follow-up actions, such as one or more follow up URLs, and the like.

In one embodiment, a user (117) may specify the type of report (119) or information to be presented, either at the time of placing the image-aided query (118), or configuring the system in advance, or according to the tenant's (112) policy (as explained below). In this case, the server-system (103) will consider the user's (117) settings when processing the image-aided query (118) and/or compiling the report (119). According to another embodiment, the report (119) may be displayed on the electronic device (101); and in another embodiment, the electronic device (101) may play the report (119) using an audio speaker, or present it in some other way.

In another embodiment, a user (117) can review the report (119) and provide, if necessary, some feedback (125) with additional details, if known to the user, by interacting with the report (119), where the user's (117) input is then transmitted to the server-system (103) and processed and/or recorded in one or more external (107) and/or internal collections of resources (106). Said feedback (125) system provides a mechanism for collecting new relevant data and increasing the accuracy and completeness of the existing data.

In another embodiment, a user (117) may select and annotate one or more results in the report (119), where one or more annotations may serve as an implicit feedback (125) that the results, or any part thereof, were relevant (or provide a degree of relevance or accuracy, etc.). Thus, said feedback (125) can also be used to improve the server-system (103) query (118) processing and reporting.

In another embodiment, a user's selection (e.g., click on the “correct” button) from several of the same type of results, or choosing a more relevant image (116), provide feedback (125) to the server-system (103), improving the accuracy and completeness of the report (119), and providing additional information and/or enhancing the existing information. The feedback (125) can include, for example, without limitations: a binary response (e.g., yes/no, true/false, good/bad, etc.), and/or a scaled response (e.g., from a scale of 1 to 10), etc.

In one embodiment, the server-system (103) can determine critical information gaps regarding an individual and/or related subject or object, and provide, for example, an interactive questionnaire as part of the report (119) for user (117) to provide any known information. The response is then submitted to the server-system (103) as feedback (125). In another implementation, such questionnaire is generated by the server-system (103) and/or the device (101) according to some configuration and logic and then provided as part of the report (119) or separate from the report (119).

Said feedback (125) can be a clarification, a correction, additional information, a description, a review, and the like. For instance, the feedback (125) may indicate a person's most current telephone number or most resembling image, etc. In one embodiment, the feedback (125) is sent to the server-system (103), and the front-end server (126) receives the feedback (125) and processes it as appropriate.

In one embodiment, the server-system (103) pushes a report (119) to one or more electronic devices (101) in one or more transactions or communication sessions. Alternatively, the electronic device (101) pulls a report (119) from one or more server-systems (103) (or one or more modules of one or more server-systems (103)) in one or more transactions or communication sessions. In another implementation, the electronic device (103) also obtains additional data from one or more external systems (110) and/or one or more external collections of resources (107), and/or obtains the report (119) from an intermediary system that stores such report (119). And in another embodiment, an electronic device (101) compiles at least some part of the report (119) after receiving some data from one or more server-systems (103) and other system(s).

According to the present teachings in one or more aspects, and as exemplified in the FIG. 3, the proposed system consists of a plurality of client electronic devices (101) that are communicatively coupled over a network (102) with one or more server-systems (103). In one embodiment, the electronic device (101) consists of circuitry that has one or more processors and memory storing programs of instructions that can be executed by one or more processors. Said client electronic device (101) includes physical and logical network interfaces for wired and/or wireless communications, such as LAN, WAN, Wi-Fi, Bluetooth, GSM/CDMA, LTE, USB, CAN, etc.

In another embodiment, a client electronic device (101) has one or more operatively and/or communicatively coupled electronic monitors or displays, and a user interface accessible by the device user (117). In another embodiment, said electronic device (101) has operatively and/or communicatively coupled one or more video cameras capable of capturing images, either continuously or upon a certain event. In another embodiment, an electronic device (101) can access a memory that is operatively and/or communicatively coupled with said device (101) to obtain one or more images from said memory.

In another embodiment, an electronic device (101) is operatively and/or communicatively coupled with one or more sensors in a way that it can receive information from such sensors, for instance, without limitations: environmental sensors (temperature, pressure, humidity, etc.), human-wearable sensors (step-meter, heart rate meter, body temperature meter, O2 meter, glucose meter, and the like), Location-Based Services (LBS) sensors, gyro and proximity sensors, movement detection sensors, tripwire sensors, vibration sensors, heat sensors, and the like.

In another embodiment, a client electronic device (101) acquires and pre-processes an image, either using a video camera or accessing a memory, and initiates an image-aided query (118). Once the image is acquired, the device user (117) makes one or more inputs to designate one or more objects of interest (120) in the image. Alternatively, once the image is acquired, said electronic device (101) detects one or more objects (120) based on clusters of salient features or features of interest, and highlights said objects (120). In another embodiment, a user (117) can make one or more inputs to indicate a selection of at least one of the objects (120), whether detected by user (117) or prior detected by the device (101). In another embodiment, said device (101) can compare one or more objects (120) with one or more locally or remotely stored templates in order to identify the objects (120), and/or categorize the objects (120) by type or other criterion.

In another implementation, the electronic device (101) can extract one or more sub-images or some other data from the acquired image, based on the categorized or recognized objects (120) and/or some user (117) settings. In another embodiment, an electronic device (101) can automatically (without user's (117) involvement) generate some annotation data based on one or more recognized and/or categorized objects (120) in the image as part of the image-aided query (118) parameters acquisition.

In another embodiment, an electronic device (101) acquires and pre-processes an image as part of the image-aided query (118) parameters acquisition, where said image or a sub-image extracted therefrom is pre-processed, either together with annotations or not, in a way that it is transformed (e.g., encrypted, compressed), or otherwise altered for whatever reason (e.g., to optimize transmission or processing, etc.). In another embodiment, an electronic device (101) acquires an image and/or other parameters of the image-aided query (118), and pre-processes them as described above but does not transmit the image-aided query (118) to a server-system (103) until sometime later or upon a certain event, thus differing the transaction as, for example, in case of a network or system unavailability, power management reasons, batch transaction processing, or if configured by user (117), etc.

In one embodiment, the communications between one or more electronic devices (101) and one or more server-systems (103) are enabled via the following communication protocols, for example, without limitations: electronic mail (e-mail), short message service (SMS), multimedia messaging service (MMS), enhanced messaging service (EMS), WAP push, application push (e.g., push registry, etc.), a standard form of telephony, or standard internet protocols such as Transmission Control Protocol (TCP), IP, User Datagram Protocol (UDP), hypertext transfer protocol (HTTP), File Transfer Protocol (FTP), publish-subscribe protocols, or any other protocols.

According to one embodiment, and per the example in the FIG. 3, a server-system (103) consists of a circuitry, and in another embodiment, of a single computer, and yet in another embodiment, of a distributed computing system that includes one or more image analysis systems (104), and operatively and/or communicatively coupled one or more search systems (105), and operatively and/or communicatively coupled one or more collections of resources (106).

In another embodiment, said image analysis system can be an external image analysis system (109), or a combination of one or more external (109) and one or more internal (104) image analysis systems, configured to operate concurrently or consecutively. In another embodiment, said search system can be an external search system (108), or a combination of one or more external (108) and one or more internal (105) search systems, configured to operate concurrently or consecutively. And in another embodiment, said collection of resources can be an external collection of resources (107), or a combination of one or more external (107) and one or more internal (106) collections of resources, whether coupled or not (e.g., federated, mirrored, synchronized, etc.).

According to one embodiment, the server-system (103) is a multi-tenant system, serving multiple tenants (customers) (112), where the tenants' resources are segregated programmatically (e.g., application-level access control), and/or using virtualization technologies, and/or using network-level separation, and/or using hardware-level separation. Said multi-tenancy, in one implementation, is accomplished via a virtualization technology, where the resources of each tenant (112) are segregated into one or more virtual computing nodes; and in another implementation, the multi-tenancy is achieved using programmatic access control-based separation via a reference monitor or similar technology; and in another implementation, the multi-tenancy is accomplished using network-based access control, such as private or hybrid networks (clouds), subnets, etc.; and yet in another implementation, the multi-tenancy is accomplished using separate physical computing nodes, or a combination of the aforesaid technologies.

In another embodiment, the server-system (103) represents a high-assurance distributed computing infrastructure that comprises of multiple redundant multi-regional operating environments that provide high service availability; and the server-system (103) is constructed to comply with NIST 800-53 or similar current then recommendation regarding security and privacy controls of the Federal Information System, as well as to comply with Health Information Portability and Accountability Act (HIPAA) Security Rule, Technical Safeguards, and NIST 800-66 HIPAA Security Rule implementation or similar current then recommendation, and/or other relevant standards and guidelines pertaining to the Federal Information Systems, healthcare and financial information systems, as well as specific requirements for handling sensitive or controlled information of various governmental agencies. Where in one embodiment, the systems, components, and methods of the proposed invention can provide multi-level and/or compartmented access control and operation (Multi-Level Security).

In another embodiment, the server-system (103) includes an application programming interface (API) (121) that facilitates communicative coupling of the server-system (103) and multiple external systems (110), and/or multiple external image analysis systems (109), and/or multiple external search systems (108), and/or multiple electronic devices (101), and/or multiple external collections of resources (107). In another embodiment, the server-system (103) is implemented using Service Oriented Architecture (SOA) design principles.

In another embodiment, the server-system (103) includes a user interface (UI) (122), where in one embodiment, the UI allows one or more server-system administrators to administrate the server-system (103). And in another embodiment, the UI allows one or more administrators of one or more tenants (112) to administrate the tenant's resources and/or the tenant-applicable server-system settings. The resources and settings may, without limitations, in one implementation, include a plurality of: images, annotations, data-sets, documents, software, circuitry, access control rules, notification rules, wiki-type profiles (123), integrations with tenant's private information systems and resources (e.g., Active Directory/LDAP integrations, private or hybrid clouds, telecommunication systems, private databases, private image analysis and search systems, etc.). In another embodiment, said users (117) may belong (be grouped) to one or more tenants (112) and can access the server-system (103) using a user interface (122), where such users can, for instance: review the reports (119), review and/or edit images and/or metadata, review and/or edit wiki-type profiles (123), manage personal settings and perform other actions.

In one embodiment, the server-system (103) includes one or more front-end servers (126) or another circuitry and a system of load balancers, where the front-end server (126) or another circuitry is one or more web-servers that, in one implementation, reside in a private subnet, accessing the Internet through a system of proxy servers that reside in a demilitarized zone (DMZ) subnet. According to one implementation, the front-end server (126) or other circuitry provides an API interface (121), and receives one or more image-aided queries (118) from one or more electronic devices (101). In another embodiment, one or more external (109) and/or internal image analysis systems (104), and/or external (108) and/or internal search systems (105) receive one or more image-aided queries (118) directly from one or more electronic devices (101), where in one implementation, said systems provide APIs (121) accessible over a network (102).

In another implementation, said front-end server (126) or other circuitry, upon receiving an image-aided query (118), executes some processing logic, sending the image to one or more internal (104) and/or external image analysis systems (109) for concurrent or consecutive processing, and/or storing the image in one or more external (107) and/or internal collections of resources (106), and/or sending the image to one or more external systems (110), and/or performing other actions. And in another implementation, the front-end server (126) or other circuitry, upon receiving an image-aided query (118), executes some part of the processing logic, sending the annotation data to one or more internal (105) and/or external search systems (108) for concurrent or consecutive processing, and/or storing the annotation data in one or more external (107) and/or internal collections of resources (106), and/or sending said annotation data to one or more external systems (110), such as language translation or linguistic analysis system for multilingual or culture-aware processing.

And in another implementation, the front-end server (126) or another circuitry receives the results of processing one or more images and annotation data from an external (109) and/or internal image analysis system (104), and/or external (108) and/or internal search system (105), and executes some analytic action, according to the analytic action configuration, generating additional results or transforming at least some data of the received results, and then sending at least some data of said results to one or more internal (104) and/or external image analysis systems (109), and/or to one or more internal (105) and/or external search systems (108) for concurrent or consecutive processing, and/or to one or more external systems (110), such as a language translation service or linguistic analysis system.

In another embodiment, said one or more front-end servers (126) or other circuitry receives one or more image-aided queries (118) from one or more electronic devices (101). And the query image may include or consist of at least some pre-processing data generated on the electronic device (101), as described earlier. Accordingly, the front-end server (126) or another circuitry executes at least some image-aided query (118) processing logic, sending the image data to one or more internal (104) and/or external image analysis systems (109) for concurrent or consecutive processing. If one or more front-end servers (126) or other circuitry receives the pre-processed image, for instance, containing the information about the likelihood that a sub-portion of the image contains an object of a certain type, the front-end server (126) may pass this data to one or more image analysis systems (104, 109) tailored to process such object type, and/or to one or more such search systems (105, 108), and/or to some other circuitry, and/or the front-end server (126) may store this data in one or more collections of resources (107, 106).

In one embodiment, the one or more front-end servers (126) may receive at least some post-processing feedback (125) information, as described earlier, that user (117) provides in connection with the report (119). If one or more front-end servers (126) or other circuitry receives the feedback (125), it may pass this data to one or more image analysis systems (104, 109), and/or to one or more search systems (105, 108), and/or to some other circuitry, and/or it may store this data in one or more collections of resources (107, 106).

In another implementation, the front-end server (126) or other circuitry may not pass said pre-processing and/or post-processing information as described above, but will instead use this information to augment the way it processes the results received from an image analysis system (104, 109), and/or search system (105, 108), or another system as explained earlier.

In one embodiment, one or more external (109) and/or internal image analysis systems (104) implement discrete or cooperative image processing function, using one or more image analysis techniques, including but not limited to: content-based image analysis, concept-based image analysis, and context-based image analysis, known to those skilled in the art. In one implementation, the external (109) and/or internal image analysis system (104) consists of a program of instructions executed by one or more processors; in another—a circuitry; and in another—one or more computers; and yet in another—a distributed computing infrastructure; and in another—an external image analysis service.

In one embodiment, one or more external (109) and/or internal image analysis systems (104) are operatively and/or communicatively coupled with one or more external (107) and/or internal collections of resources (106). In one implementation, the image analysis systems (104, 109) are operatively and/or communicatively coupled with a single external (107) and/or internal collection of resources (106). And in another implementation, the image analysis systems (104, 109), each, is operatively and/or communicatively coupled with one or more individual external (107) and/or internal collections of resources (106), as well as in any combination and arrangement thereof as necessary to process an image-aided query (118).

According to one implementation, a face recognition image analysis system (104, 109) accesses a facial image collection of resources (106, 107) to look for facial matches to the image-aided query (118). If an image contains a face, the facial recognition image analysis system (104, 109) returns one or more search results (e.g., some identifying indicia of a matching image and/or object(s), and/or other information such as a similarity score, etc.). In another embodiment, the Optical Character Recognition (OCR) image analysis system (104, 109) converts any recognizable text in the image into text for return as one or more results of image analysis. In another embodiment, one or more image analysis systems (104, 109) generate a semantic search query based on at least one recognized object, and/or some metadata, and/or contextual data associated with one or more images; and in another implementation, one or more image analysis systems (104, 109) generate a semantic search query based on user feedback (125) as explained earlier.

According to one embodiment, there is a plurality of concurrently or consecutively operating external (109) and/or internal image analysis systems (104) that include without limitations: a facial recognition system; an OCR image recognition system; an image-to-terms image recognition system that recognizes an object or an object category; a 2-D entity image recognition system; a 3-D entity image recognition system; a 3D pose estimation system; a motion estimation system; a facial emotion recognition system; an image restoration/enhancement system; a named entity image recognition system; a landmark image recognition system; a corpus of specific images recognition system, such as radio-magnetic and acoustic images, ultra-high resolution images, fingerprint images, and other forensic and biometric images; a place recognition system aided by geo-location information; a color recognition image analysis system; and similar image analysis systems. In another embodiment, one or more external (109) and/or internal image analysis systems (104) can be added and removed as needed, statically and/or dynamically (e.g., “on-the-fly”, on demand, etc.).

In one embodiment, the server-system (103) may be connected to a network (102), and may search multiple external collections of resources (107) on the network, and collect visually similar images to one or more images of one or more image-aided queries (118), based on the detected visual features—content-based analysis. Visual similarity may be detected or determined, for example, using a comparison of feature vectors, color or shape analysis, or the like. In one example, one or more visually similar images are collected that have similar visual features to those detected in one or more images of one or more image-aided queries (118). In an alternate embodiment, the visually similar images are collected from other sources, such as a memory or a network-based data storage system. The visually similar images may be collected and stored in memory or similar electronic storage, and/or one or more collections of resources (106, 107) that are local or remote to the server-system (103).

In another embodiment, one or more external (109) and/or internal image analysis systems (104) can perform context-based image analysis and/or concept-based image analysis to examine textual information associated with one or more image-aided queries (118) and/or visually similar images (to the query images), where such images, in one implementation, reside in one or more external (107) and/or internal collections of resources (106), such as, without limitations: published on a digital medium, or a website accessible over the Internet, or a password-protected database, or a file system, etc.

The context-based image analysis system (104, 109), in one embodiment, comprises of: an identification module configured to identify an image published on a digital medium and text published proximate to the image; and a processor that receives and analyzes images and text to obtain a contextual descriptor by matching at least some image metadata with at least some textual data corresponding to the image. The textual descriptor may function to describe, identify, index, or name the image or content within the image. Said context-based image analysis system (104, 109) may be further configured to determine a confidence level for the matched images and textual data, etc.

In another embodiment, a context-based image analysis system (104, 109) accumulates text from proximity of one or more images, where in one implementation, it may detect text in proximity of images while searching for images that are visually similar to the image-aided query (118). The context-based image analysis system (104, 109) may be programmed, for example, to accumulate text that appears on the same document page or resource as the visually similar image or within a predefined distance of the visually similar image that may include predefined tags. The text may be a header or the body of an article where the visually similar image appears. The text may be a caption to the visually similar image, a sidebar, information box, category tag, or the like. The context-based image analysis system (104, 109) may accumulate the text it encounters to determine the object (120) name, displayed in the query (118) image. For example, the server-system (103) may compute a correlation between a name detected in the accumulated text and the image.

In another embodiment, a context-based image analysis system (104, 109) may accumulate text from a proximity of multiple visually similar images, increasing the amount of text available for analysis. And in alternate embodiments, the context-based image analysis system (104, 109) may perform multiple searches for visually similar images based on a single query (118) image. Yet in another embodiment, the context-based image analysis system (104, 109) may aggregate accumulated text from one or more of the multiple searches when the search results in duplicate visually similar images. For example, if the context-based image analysis system (104, 109) encounters duplicate visually similar images, the system may aggregate text that is proximate to the visually similar images to improve the identification of one or more objects (120) in the image.

According to another embodiment, one or more external (109) and/or internal image analysis systems (104), and/or external (108) and/or internal search systems (105) can filter the accumulated text to obtain candidate names of one or more objects (120) in an image, as well as structured data associated with the image. Structured data, for example, may include information related to: a date of birth, an occupation, a gender of an object-person (120), and the like. In alternate embodiments, one or more filters may be employed to filter the accumulated text. For example, one technique includes using a large-scale dictionary of occupations as a filter. In one embodiment, a large-scale dictionary of occupations may be produced from an online information source, a knowledge base, or other collections of resources, and used to filter the accumulated text to extract titles (i.e., a job title). In other embodiments, other information sources such as a nationality classifier, for example, may be used to produce lists of nationalities or similar filters.

In an alternate embodiment, for example, a job title or similar information may be recognized in the accumulated text by various techniques. For instance, a job title may be recognized if the job title and the last name of an object-person (120) occur as a phrase in the accumulated text. In another embodiment, a job title may be recognized in the accumulated text if a partial match of an object-person's (120) title occurs in the accumulated text. For example, either the first or the last name of an object-person (120) in combination with a job title may be present. Additionally, or alternately, a job title may be recognized in the accumulated text if a combined name and job title occur in the accumulated text. For example, a concatenated term may be present in the accumulated text.

In alternate embodiments, other techniques may be employed to recognize, for example, job titles in the accumulated text, including linguistic analysis, cultural context, language translation, etc. For example, a plurality of name recognition algorithms may be used that recognize capitalization, look for key words and phrases, look at the content or context of the surrounding text, and the like. In various embodiments, algorithms may be used to determine the accuracy or correctness of the information. In alternate embodiments, more than one name may be correct for an object (120) (e.g., a person with several names or aliases may be detected), or an image may include more than one object (120), etc.

According to one embodiment, one or more external (109) and/or internal image analysis systems (104) individually process one or more images of the image-aided query (118) and return their results to one or more front-end servers (126) and/or to another circuitry. In some embodiments, one or more front-end servers (126) or other circuitry executes one or more analytic actions on the results of one or more image analysis. The analytic actions, without limitations, may include: combining at least some information produced by at least two of the plurality of image analysis systems (104, 109) into a compound result; combining at least one of the plurality of image analysis results and at least one of the plurality of search results into a compound result; aggregating the results into a compound document; choosing a subset of results to store and/or present; and ranking the results as configured by the ranking logic. In another embodiment, one or more image analysis systems (104, 109) implement machine learning techniques for the image-aided query (118) processing, such as, without limitations: predictive analytics, learning to rank, computer vision, and others.

With the benefit of annotations and other metadata, the server-system (103) can produce more complete and germane results. However, the primary use of annotations in the proposed invention is to collect relevant knowledge about the objects (120) of interest. The image recognition function (104, 109) discussed in this invention is supplemental to the annotation collection, providing additional visual information and enhancing the accuracy and completeness of content retrieval.

As previously described, in one or more embodiments, the server-system (103) includes a front-end server (126) or another circuitry, where the front-end server (126) or another circuitry provides an API interface (121) and receives one or more image-aided queries (118) from one or more electronic devices (101). The front-end server (126) or other circuitry, in one implementation, upon receiving an image-aided query (118), executes some processing logic, sending the annotations and other metadata to one or more internal (105) and/or external search systems (108) for concurrent or consecutive processing, and/or to one or more external systems (110), such as a language translation or linguistic analysis system.

In one implementation, the front-end server (126) or another circuitry, upon receiving an image-aided query (118), as depicted in the FIG. 5, executes some processing logic, concurrently sending (in parallel) some data of the image-aided query (118) (represented by “1” and the solid-line arrows in the FIG. 5) to one or more internal (104) and/or external image analysis systems (109), and to one or more internal (105) and/or external search systems (108); and in another implementation, to one or more external systems (110), or in any combination of said systems and steps.

And in another implementation, after receiving at least some results from one or more of the systems (as exemplified by “1” and the dash-line arrows in the FIG. 5), processing a request in parallel, executing some analytic action, according to the analytic action configuration, whether generating additional results and/or transforming at least some of said results, and/or storing at least some of the results in one or more external (107) and/or internal collections of resources (106), and/or performing some other or no actions at all. And in another implementation, submitting at least some of the results and any other data for further processing by one or more of the systems, or some other system; and performing as many of such iterations as necessary. The described steps, the systems employed, and the data produced or manipulated with, can be combined, amended, repeated, and used in any combination, sequence, and/or permutation.

In another implementation, the front-end server (126) or another circuitry, upon receiving an image-aided query (118), as depicted in the FIG. 6, executes some processing logic, consecutively (or consecutively and concurrently) sending some data of the image-aided query (118) (as represented by the sequence number and the solid-line arrows in the FIG. 6) to one or more internal (104) and/or external image analysis systems (109), and/or to one or more internal (105) and/or external search systems (108), and/or to one or more external systems (110); and receiving at least some results from said system(s) (as represented by the sequence number and the dash-line arrows in the FIG. 6), executing some analytic action, according to the analytic action configuration, and/or generating additional results, and/or transforming at least some of the results, and/or storing at least some of said results in one or more external (107) and/or internal collections of resources (106), or performing some other or no actions at all.

And in another implementation, submitting at least some of the results and any other data for further processing by one or more of the systems, or some other system; and performing as many of such iterations as necessary. The described steps, the systems employed, and the data produced or manipulated with, can be combined, amended, repeated, and used in any combination, sequence, and/or permutation.

The proposed invention relates to the systems and methods for data collection and retrieval using an image-aided query (118). As already mentioned, the image analysis process discussed herein, provides, besides information collection, an additional mechanism for more accurate and complete data retrieval. The data retrieval is performed by one or more internal (105) and/or external search systems (108) operatively and/or communicatively coupled with one or more external (107) and/or internal collections of resources (106); and in some embodiments with one or more internal (104) and/or external image analysis systems (109). In one implementation, the external (108) and/or internal search system (105) consists of a program of instructions executed by one or more processors; and in another—a circuitry; and in another—one or more computers; and yet in another—a distributed computing infrastructure; and in the other embodiment—an external search engine service.

Said search system (105, 108) can locate and provide relevant information in response to a search query from one or more front-end servers (126) or another circuitry, and/or one or more external systems (110), and/or one or more electronic devices (101), and/or one or more image analysis systems (104, 109), as explained earlier. In one implementation, the search system (105, 108) is configured to search static data; and in another implementation, the search system (105, 108) is configured to search steaming data (e.g., computer network traffic, phone conversations, ATM transactions, streaming sensor data, etc.).

In one embodiment, one or more external (107) and/or internal collections of resources (106) may contain textual, and/or visual, and/or other information that relates or includes, but not limited to the following: information about previous processing of one or more images, person's biographical information, demographical information, academic information, employment-related information, address and location information, contact information, social network-related information, criminal and court records-related information, motor vehicle-related information, financial and credit-related information, risk management-related information, property records-related information, biometric information, medical information, Internet-based records, telephone records, telecom records (communications and/or metadata), government records, media records, objects/subjects associations and connections-related information, personal preferences-related information, relationships-related information, affiliations-related information, biometrics-related information, and genealogical information, etc.

According to one implementation, one or more search systems (105, 108) can execute some analytic action, as configured in the search logic, to determine what information and in what external (107) and/or internal collections of resources (106) it shall be searched, in order to locate and provide the relevant information (e.g., searching a registry database first, etc.); and what search enabling technology to employ (e.g., distributed search, parallel search (e.g., MapReduce), data stream mining, etc.); and what search algorithms to use; and what search techniques shall be applied (e.g., discovering, crawling, transformation, indexing, cataloging, keyword searches, natural language searches, data mining, deep and dark web mining, etc.). In one embodiment, the search system (105, 108) or other circuitry may determine the search parameters based on the results generated by one or more image analysis systems (104, 109), and/or search systems (105, 108), and/or external systems (110).

In another implementation, the content of the search results can be filtered to enhance the search relevancy and/or it can be sanitized to remove private or personal information (e.g., to comply with legal or business requirements, etc.). In another implementation, the search system (105, 108) can locate and index information stored in one or more external (107) and/or internal collections of resources (106) to be able quickly locate relevant information by accessing indexes in response to a search query, providing a near real-time response. Furthermore, the search system (105, 108) or other circuitry can amend search results based on the query (118) annotation data and other metadata, and/or contextual data.

In one embodiment, one or more image analysis systems (104, 109) may generate one or more image-aided query-related images and/or visually similar images (or their identifying indicia) as a result of image analysis, including information based on one or more recognized objects (120). One or more search systems (105, 108) can then perform a semantic or other search, based on at least some annotation data of the recognized object(s) (120), or other metadata, and/or contextual data associated with said image, as well as any feedback (125) associated with previous and/or current data retrieval queries (118).

In one embodiment, the server-system (103) includes a repository (one or more collections of resources (106, 107)) containing personal wiki-type profiles (123) of the encountered individuals or other targets (people, places, events, etc.). The server-system (103) assembles a wiki-type profile (123) for each encountered individual, where said profile (123) consists of the information compiled by processing the image-aided queries (118), the relevant information provided by users (117), and information amassed from other resources that are not part of the query (118) processing.

In one implementation, a wiki-type profile (123) can be presented as part of the report (119); and in another implementation said profiles (123) can be accessed by users via a user interface (122) (e.g., using a network-enabled computer or a mobile device, etc.). In one embodiment, each tenant (112) (customer) may have separate (private) one or more repositories, where the separation is achieved, but not limited to: programmatic resource segregation (e.g., application-level access control), and/or using virtualization technologies, and/or using network-level separation, and/or using hardware-level separation, etc.

In one embodiment, and as exemplified in the FIG. 8, a user starts an online video conference with one or more participants using a teleconferencing application installed on a mobile device (101) (201). The user then captures a facial image of one of the participants (120) using the application interface (115) (202). User verifies the image to make sure that the image quality and the face positioning is suitable (203). User also enters some annotation information related to the individual (participant) and/or the meeting details, or anything else that is directly or indirectly related to the individual (115). For example, the participant's email (if known) and a photograph of participant's car (if available), etc., (204). The teleconferencing application adds a timestamp, the IMEI identifier of the mobile device, and the phone number (SIM)—additional annotations and metadata (205). The user then submits the image-aided query (118) to the distributed computing system (103) for processing via the application interface (115) (206).

In one embodiment, and as exemplified in the FIG. 9, a front-end server (126) that consists of an API gateway (121) that receives network requests and a distributed application server that processes the requests, receives an image-aided query (118) (207). The application server parses the query request (118) and submits the image, the annotations, and other metadata to the image analysis system (104, 109) that executes content-based, concept-based, and context-based image analysis (208). The image analysis system identifies a face in the image and searches for similar images and associated data. Once the information from the above analyses is collected (images, textual results, metadata) and the individual on the image is probabilistically identified, the application server assigns an identifier (new or existing) to the object (120) identified in the image and makes the results available to the application server (209).

In the interim, the application server also submits annotations and other metadata to multiple search systems (105, 108) (210). Where one search system looks for images associated with annotations and other metadata (or an image analysis system (104, 109), depending on the implementation) (210a). And another search system looks for text associated with annotations and other metadata in a plurality of data storage systems (collections of resources (106, 107)) (210b).

The application server then receives the results from all systems, processes them according to the preconfigured logic; and in one implementation, submits the processed results for additional processing to the image analysis system (104, 109) and/or the search system (105, 108) (211). The application server again receives the results, analyzes them; and in another implementation, makes requests to external systems (110) for additional data or processing, receives the responses and conducts additional analytic processing to infer additional knowledge (212).

The application server, in one implementation, sends an SMS message if a certain condition is met to multiple mobile devices or other computing systems, based on the results of the image-aided query (118) processing described above, and some configurations (213). In addition, the application server compiles a report (119) from said processing results, according to customer's (112) settings (214). The application server then sends a push message to the device (101), notifying the user that the report (119) is ready (215). In addition, the application server records some reported results into a special repository containing wiki-type profiles (123) of each encountered person, where it adds this information to an existing profile (123) or creates a new one if the person is encountered for the first time (216).

In one embodiment, and as exemplified in the FIG. 10, while the user is still in the video conference, the application (101) receives a push message from the distributed computing system (103), notifying the user that the report (119) is ready (217). If the user opts to show the report, the application (101) retrieves the report (119) from the distributed computing system (103) and displays it to user in a presentation interface (116) (218). User views the report (119) while in the conference call (or later), where the report has multiple topics grouped in tabs, consisting of text and images (116) (219). Optionally, the user may provide additional information (if known) and/or request more information about one or more of the report's topics by sending feedback (125) to the distributed computing system (103) (220). The application (101) then transmits the feedback (125) to the distributed computing system (103) for storage and processing, and some information from feedback may be used to trigger additional processing, modifying the information in the individual's wiki-type profile (123) and/or elsewhere (221).

The above identified modules or programs (i.e., sets of instructions) need not be implemented as separate software programs, procedures or modules, and thus various subsets of these modules may be combined or otherwise rearranged in various embodiments. Each of the operations described here in or shown in the corresponding images may correspond to instructions stored in a computer memory or non-transitory computer readable storage medium.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or system for attaining the disclosed result, as appropriate, may separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. A circuitry-implemented system for processing image-aided data collection and retrieval:
having one or more electronic devices with one or more processors and memory storing one or more programs for execution by the one or more processors, and having one or more network interfaces:
where the said memory is configured to store one or more images that contain at least some feature of at least one object of the following type: an OCR character, a person, a non-human object; and
where the said memory is configured to store one or more user-generated or electronic device-generated annotations of the one or more said objects; and
the said one or more electronic devices are configured to transmit using one or more network interfaces, at least some data of one or more image-aided queries which consist of at least some image data and at least some annotation data; and
having one or more server-systems with one or more processors and memory storing one or more programs for execution by the one or more processors, and having one or more network interfaces, and one or more image analysis systems, and one or more search systems, and one or more collections of resources:
where one or more network interfaces are configured to receive at least some image-aided query data; and
the said one or more image analysis systems are configured to process at least some data of the said one or more images by:
subjecting at least some data of the said one or more images to image analysis for determining at least some property related to one or more objects or absence thereof in the said image data, using at least one of: content-based, concept-based, and context-based image analysis; and
the said one or more search systems are configured to process at least some image-aided query data by:
performing one or more searches in one or more collections of resources using at least some annotation data; and
performing one or more searches in one or more collections of resources, using at least some data produced as a result of image analysis; and
the said one or more collections of resources are configured to store at least some data related to, or being a result of at least some previous image-aided query transaction; and
the said one or more server-systems are configured to transmit via one or more network interfaces, at least some data obtained as a result of processing the said one or more image-aided queries, where the said data includes at least some data in connection with one or more persons, or subjects or objects associated with one or more persons.

2. The system of claim 1, where at least one of: the said one or more collections of resources, the said one or more image analysis systems, the said one or more search systems are external.

3. The system of claim 1, where the said image analysis system and the said search system are operatively coupled logical subsystems of a single system.

4. The system of claim 1, where the said one or more server-systems are configured to transmit via one or more network interfaces, one or more notification messages as a result of processing one or more image-aided queries.

5. The system of claim 1, where the memory of one or more electronic devices is configured to store at least some data derived as a result of processing the one or more images, or at least some data derived as a result of processing at least some annotation data.

6. The system of claim 1, where one or more electronic devices or server-systems have a user interface, where one or more users can configure at least some settings or access at least some information related to an image-aided query.

7. The system of claim 1, where the said one or more electronic devices are configured to receive one or more packets of data in one or more transmission sessions, and the said one or more server-systems are configured to send one or more packets of data in one or more transmission sessions related to a single (one) image-aided query.

8. The system of claim 1, where the said one or more electronic devices are configured to receive from one or more server-systems at least some data obtained as a result of processing the said one or more image-aided queries, and the said one or more electronic devices are configured to transmit to the server system at least some data after receiving the said data obtained as a result of processing the said one or more image-aided queries from the server-system.

9. The system of claim 1, where the said electronic device or the said server-system are communicatively and/or operatively coupled with a plurality of other circuitry-implemented systems.

10. A circuitry-implemented method for processing image-aided data collection and retrieval, where:
one or more electronic devices:
acquire one or more images, where one or more images contain at least some feature of one or more objects of the following type: an OCR character, a person, a non-human object; and
obtain one or more user-generated or electronic device-generated annotations of one or more objects; and
transmit over a network at least some data related to one or more image-aided queries which consist of at least some image data and at least some annotation data; and
one or more server-systems:
receive at least some data of one or more image-aided queries and performs at least one of the following types of image analyses for determining at least some property related to one or more objects in the said image data: content-based image analysis, context-based image analysis, concept-based image analysis; and
performs one or more searches in one or more collections of resources, using at least some data produced as a result of at least one of the said image data analyses, resulting in locating at least some data related to one or more objects in the said image; and
performs one or more analytic actions on at least some data produced as a result of the said searches or the said image analyses; and
transmits over a network at least some data obtained as a result of processing one or more image-aided queries, where the said data includes at least some data in connection with one or more persons, or subjects or objects associated with one or more persons.

11. The method of claim 10, where the said server-system stores at least some data from the said analyses or searches, into one or more internal or external collections of resources, having one or more profiles.

12. The method of claim 10, where the said image analysis involves searching one or more collections of resources using at least some object annotation data or image metadata.

13. The method of claim 10, where the said server-system receives at least some data of one or more image-aided queries and performs one or more searches in one or more collections of resources before performing at least one of the said types of image analyses for determining at least some property related to one or more objects in the said image data.

14. The method of claim 10, where the said server-system performs one or more searches in one or more collections of resources, using at least some data produced as a result of at least one of the said image data analyses, resulting in locating at least some data related to, or being a result of at least some previous image-aided query transaction.

15. The method of claim 10, where the said one or more searches in one or more collections of resources result in locating at least some data related to one or more objects in the said one or more images that includes at least one of: information about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information.

16. The method of claim 10, where the processing of the said one or more image-aided queries involves combining at least some data produced as a result of the image analyses and at least some data produced as a result of the searches into a compound result.

17. The method of claim 10, where at least one of the said analytic actions involves determining at least some relevance of at least some data produced as a result of the said image analyses or searches.

18. The method of claim 10, where the said server-system receives at least some feedback data after transmitting over a network at least some data obtained as a result of processing one or more image-aided queries, where the said feedback data includes at least some data in connection with one or more image-aided query transactions or one or more persons, or subjects or objects associated with one or more persons.

19. The method of claim 10, where the steps of the said method are integrated with a plurality of other circuitry-implemented methods.

20. A method for collecting and presenting information associated with one or more persons, or subjects or objects associated with one or more persons, comprising of:
obtaining one or more images, where one or more images contain at least some feature of one or more objects of the following type: an OCR character, a person, a non-human object;
and obtaining at least some user-generated or electronic device-generated annotation data of one or more objects; and
identifying one or more objects from the said one or more images using at least one of the following types of image analyses: content-based image analysis, context-based image analysis, concept-based image analysis; and
assigning one or more identifiers to the said one or more objects, and saving at least some part or some product of the said one or more images and at least some part or some product of the annotation data in one or more collections of resources; and
comparing at least some part or some product of the said one or more images with at least some part or some product of images or other data stored in one or more collections of resources; and
performing one or more searches in one or more collections of resources, using at least some data produced as a result of comparing at least some part or some product of the said images; and
performing one or more analytic actions on at least some data produced as a result of the said searches; and
transmitting over a network at least some data that includes at least one of: information from/about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information.

21. The method of claim 20, where after transmitting over a network at least some data, the method includes receiving over a network at least some feedback data, where the said feedback data includes at least some data in connection with one or more image-aided query transactions or one or more persons, or subjects or objects associated with one or more persons.

22. The method of claim 20, where the said method includes a step of searching one or more collections of resources using at least some annotation data or metadata.

23. A method for processing image-aided data collection and retrieval, comprising of:
receiving one or more images and storing at least some data associated with the said one or more images; and
identifying in the said one or more images one or more persons, or subjects or objects associated with one or more persons; and
quarrying at least some data that includes at least one of: information from/about previous searches, biographical information, demographical information, academic information, employment-related information, address and location information, contact information, social network-related information, criminal and court records-related information, motor vehicle-related information, financial and credit-related information, risk management-related information, property records-related information, biometric information, medical information, the Internet-mining records, government records, media records, telecommunications-related records, forensic records, associations and connections-related information, preferences-related information, relationships-related information, and genealogical-related information; and
transmitting over a network or displaying on a visual display at least some data obtained as a result of processing one or more images, where the said data includes at least some data in connection with one or more persons, or subjects or objects associated with one or more persons.
